(19) United States
(12) Patent Application Publication
(10) Pub. No.: US 2011/0004629 A1
(43) Pub. Date: Jan. 6, 2011

(54) Method and System for Automating the Migration of User Settings from a First Domain to a Second Domain

(75) Inventors: Nishant Thorat, Pune (IN); Arvind Raghavendran, Secunderabad (IN); Pallavi Koganti, Secunderabad (IN)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/497,376

(22) Filed: Jul. 2, 2009

(51) Int. Cl. G06F 17/30; G06F 15/16; G06F 3/048

(52) U.S. Cl. 707/783; 709/206; 715/700; 707/770

(57) ABSTRACT

A method for automating the migration of a plurality of user settings associated with a user from a first domain to a second domain, includes receiving a plurality of user settings associated with a user of a computer associated with a first domain. The method also includes configuring the computer associated with the first domain for association with a second domain. The method further includes creating a user profile of the user of the computer associated with the second domain, such that the user profile comprises at least one of the plurality of the user settings associated with the user of the computer.

### TECHNICAL FIELD

The present disclosure relates generally to migrating computers from a first domain to a second domain, and more particularly for automating the migration of user settings from a first domain to a second domain.

### BACKGROUND

A company merging with or acquired by another company may be required to migrate a large number of computers and users to a new domain. Typically, network administrators manually enter new information for each computer and user to be added to the new domain. This process can be very time consuming and is prone to many errors.

### SUMMARY

In accordance with the teachings of the present disclosure, a system for automating the migration of user settings from a first domain to a second domain is provided. The system includes one or more processors and memory coupled to the one or more processors and configured to store program instructions executable by the one or more processors to receive a plurality of user settings associated with a user of a computer associated with a first domain. The one or more processors are also configured to configure the computer associated with the first domain for association with a second domain. The one or more processors are further configured to create a user profile of the user of the computer associated with the second domain, wherein the user profile comprises at least one of the plurality of the user settings associated with the user of the computer.

In accordance with an embodiment, a method for automating the migration of a plurality of user settings associated with a user from a first domain to a second domain, includes receiving a plurality of user settings associated with a user of a computer associated with a first domain. The method also includes configuring the computer associated with the first domain for association with a second domain. The method further includes creating a user profile of the user of the computer associated with the second domain, such that the user profile comprises at least one of the plurality of the user settings associated with the user of the computer.

Certain embodiments of the invention may provide one or more technical advantages. For example, certain systems and methods may reduce the time required to migrate computers and users from a first domain to a second domain by automating the migration of user settings from a first domain to a second domain. Previously, a network administrator had to manually migrate the user settings from a first domain to a second domain. For example, the network administrator had to manually store the user settings from the first domain in a file, such as a DNA file, create user profiles on the second domain, map the user settings from the first domain to the second domain, and delete the user profiles associated with the first domain. In some mergers and acquisitions, a network administrator had to manually perform these tasks for hundreds or thousands of user profiles, which is very time consuming with a high error rate. As another example, certain systems and methods may reduce the amount of errors resulting from migrating computers and users from a first domain to a second domain by automating the migration of user settings from a first domain to a second domain.

Other technical advantages of the disclosed system may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and features and advantages thereof, reference is now made to the following description, taken in conjunction with the accompanying drawings, in which:

FIG. 1 is a block diagram illustrating a system for automating the migration of user settings from a first domain to a second domain in accordance with a particular embodiment;

FIG. 2 is a block diagram illustrating a migration manager executed by a computer accordance with a particular embodiment;

FIG. 3 is a block diagram illustrating a graphical user interface for automating the migration of user settings from a first domain to a second domain in accordance with a particular embodiment; and

FIG. 4 is a flowchart illustrating a method for automating the migration of user settings from a first domain to a second domain in accordance with a particular embodiment.

### DETAILED DESCRIPTION

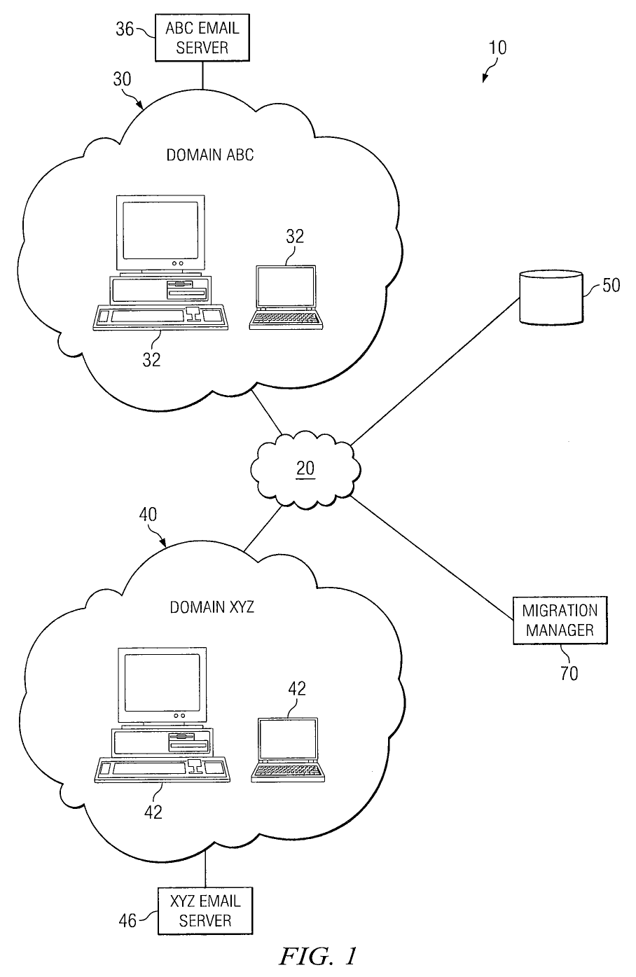

FIG. 1 illustrates a system 10 for automating the migration of user settings from a first domain to a second domain according to a particular embodiment. System 10 may include a network 20 coupled to one or more computers 32 and email servers 36 associated with a source domain 30 (domain “ABC”), one or more computers 42 and email servers 46 associated with a destination domain 40 (domain “XYZ”), and/or one or more databases 50. As illustrated, system 10 also includes a migration manager 70 for managing the migration of user settings from source domain 30 to destination domain 40 within system 10. User settings may be information associated with creating a unique computer environment for a particular user. Examples of user settings may include, but are not limited to, browser settings, screen saver settings, background settings, mouse settings, data settings, icon settings, desktop settings, network settings, application settings, display settings, and command window settings. In certain embodiments, each user has unique user settings for the computer operated by the user. Source domain 30 may refer to the domain that is to be removed from computer 32 and destination domain 40 may refer to the new domain that is to be associated with computer 42.

Embodiments of migration manager 70 may be used to automate multiple tasks for migrating the user settings of a computer from source domain 30 to destination domain 40. For example, if company BBB, which uses domain XYZ, merges with or acquires company AAA, which uses domain ABC, migration manager 70 may be used to automate the process of migrating the user settings for all of the computers operated by the users associated with company AAA on domain ABC to company BBB on domain XYZ. After migration manager 70 has completed the automation of migrating the user settings of the one or more computers from domain ABC 30 to domain XYZ 40, the one or more computers operated by each user will be configured with substantially the same settings as before the domain name change, such that the differences in the display and operation of the computer is substantially unnoticeable to the user.

In certain embodiments, migration manager 70 may determine the user settings and files of a computer 32 associated with the source domain 30 and store this information in a file. Migration manager 70 may disassociate the computer 32 with the source domain 30 and associate the computer 42 with destination domain 40. Migration manager 70 may extract the user settings and apply these user settings to a user profile. User profile may be data that comprises the user settings. Migration manager 70 may also automatically configure the email application of the user to communicate with destination email server 46 (“XYZ” email server) associated with destination domain 40 rather than the source email server 36 (“ABC” email server) associated with source domain 30. Thus, when a user logs on to computer 42 located on destination domain 40, the user's experience will be substantially similar to when the user previously logged on to computer 32 located on source domain 30.

Network 20 represents communication equipment, including hardware and any appropriate controlling logic, for interconnecting elements coupled to enterprise network 20. Network 20 may generally be any communication network capable of transmitting audio and/or video telecommunication signals, data, and/or messages. In certain embodiments, network 20 may comprise all or a portion of a public or private data network, a local area network (LAN), a metropolitan area network (MAN), a wide area network (WAN), or an enterprise intranet. Network 20 may include one or more routers, hubs, switches, or gateways. Although network 20 is illustrated as a single entity, network 20 may comprise any number of networks or interface with other networks such as Internet.

Source domain or domain ABC 30 and destination domain or domain XYZ 40 are domain names that may define a realm of administrative autonomy, authority, or control in network 20. Domain ABC 30 and domain XYZ 40 may be based on the Domain Name System, such as www.abc.com. End users or entities in network 20 can register and reserve a particular domain name to connect local area networks to Internet, run web sites, or create publicly accessible Internet resources. For example, domain ABC 30 may be registered by and associated with company AAA and domain XYZ 40 may be registered by and associated with company BBB.

One or more computers 32, 42 may be used by users associated with source domain 30 and destination domain 40. A computer 32, 42 may generally be any processor-controlled device or combination of two or more such devices capable of executing a computing operation. In some embodiments, computers 32, 42 may execute applications. Such applications may include software or other logic embodied in a computer-readable medium. An example of an application may include migration manager 70. In certain embodiments, the one or more computers 42 associated with destination domain 40 may be the same computers as the computers 32 associated with source domain 30. In certain embodiments, the one or more computers 42 associated with destination domain 40 may be different computers than computers 32 associated with source domain 30.

One or more email servers 36, 46 may be used by users associated with source domain 30 and destination domain 40. An email server 36, 46 may generally be any processor-controlled device or combination of two or more such devices capable of executing a computing operation. In some embodiments, email servers 36, 46 may execute applications. Such applications may include software or other logic embodied in a computer-readable medium. For example, email server 36, 46 may be able to process email operations and communications for each user. In certain embodiments, the one or more email servers 46 associated with destination domain 40 may be the same email servers with updated domain configurations as the email servers 46 associated with source domain 30. In certain embodiments, the one or more email servers 46 associated with destination domain 40 may be different email servers than email servers 36 associated with source domain 30.

Database 50 may store data and information associated with components of system 10. Database 50 may include any suitable software and hardware for organizing and storing data, including user settings, user files, and/or user profiles. Embodiments of database 50 may store applications that may be accessed via network 20, such as migration manager 70. In certain embodiments, database may be coupled with computers 32, 42.

Within network 20, migration manager 70 may logically reside in, or be colocated with, a computer such as, for example, one or more computers 32 associated with source domain 30 or one or more computers 42 associated with destination domain 40. In certain embodiments, migration manager 70 may be stored at a remote location.

Each computer associated with migration manager 70 may include one or more suitable input devices, output devices, mass storage media, processors, memory, interfaces, communication ports, or other appropriate components and/or software for receiving, processing, storing, and communicating information according to the operation of system 10.

In operation, migration manager 70 may manage multiple tasks for automating the migration of the user settings of a computer from source domain 30 to destination domain 40. For example, if company BBB, which uses domain XYZ, merges with or acquires company AAA, which uses domain ABC, migration manager 70 may be used to automate the process of migrating the user settings for all of the computers operated by the users associated with company AAA on domain ABC to company BBB on domain XYZ. After migration manager 70 has completed the automation of migrating the user settings of the one or more computers from domain ABC 30 to domain XYZ 40, the computers for each user will be configured with substantially the same settings as before the domain name change, such that the display and operation of the computer is substantially unnoticeable to the user.

During operation, migration manager 70 may display a graphical user interface, as illustrated in FIG. 3, to receive data to facilitate the automation of migrating the user settings of the computers from a source domain 30 to a destination domain 40. Data received by graphical user interface may include source domain name and the user name, password, and machine name of computer associated with the source domain 30. Data received by graphical user interface may also include destination domain name and the user name, password, and machine name of the computer associated with the destination domain 40. Data received by graphical user interface may also include the new email server name 46 associated with destination domain 40. In certain embodiments, user name, password, and/or machine name may be identical for both the source domain 30 and the destination domain 40. In certain embodiments, user name, password, and/or machine name for the destination domain 40 may be different than the source domain 30.

The data fields of the graphical user interface associated with the migration manager 70 may be entered by an operator of migration manager, such as a user or network administrator. Migration manager 70 may include additional functionality for the operator to select a particular user and/or a group of users, such that the user settings and files of the selected user and/or the group of users are migrated from the first domain to the second domain. In certain embodiments, operator of migration manager 70 may also select certain user settings or files to exclude migrating from the first domain to the second domain. In certain embodiments, operator of migration manager 70 may also select certain user settings and files to add to the user settings migrated from the first domain to the second domain. Operation of these functions may occur by using a mouse to check a box next to a certain user setting or file. In certain embodiments, the automated migration of the user settings and files associated with one or more computers 32 from a source domain 30 to a destination domain 40 may begin when the operator clicks the appropriate button in the graphical user interface to begin the process.

During operation, migration manager 70 may determine the user settings and files of a computer associated with source domain 30 and store this information in a file in memory. In certain embodiments, this file may be referred to as a DNA file. The DNA file may store the user settings and data that create a unique computer environment for that particular user. In certain embodiments, migration manager 70 may obtain the user settings and file information associated with the computer in source domain 30 from the user profile or any other appropriate means. In certain embodiments, migration manager 70 may use logic or scripts that may define where to retrieve certain user settings and files, such as in a particular registry key or data in memory.

During the operation, migration manager 70 may disassociate the computer with source domain 30 and associate the computer with destination domain 40. For example, migration manager 70 may use an operation from an application programming interface to disassociate the computer with source domain 30 and associate the computer with destination domain 40. In certain embodiments, this operation from an application programming interface may be provided by the operating system of the computer. Migration manager 70 may configure the registry of the computer to complete the operation of disassociating the computer with source domain 30 and associating the computer with destination domain 40. For example, migration manager 70 may prompt operator to restart the machine or may automatically restart the machine, such that migration manager 70 begins running automatically by setting a RunOnce registry key upon restarting the machine.

Migration manager 70 may extract the user settings from the file, registry, or memory of the computer and apply these user settings to a new user profile associated with destination domain 40. After the user settings have been applied to a new user profile associated with destination domain 40, the file, registry, and/or memory of computer 42 associated with the destination source 40 may be configured according to the user settings in the new user profile. In certain embodiments, migration manager 70 may use logic or scripts that may define where to retrieve certain user settings and files from the previously stored file or data in the memory or registry. In certain embodiments, migration manager 70 may map and apply the stored settings of all the network users to a new user profile for each user.

In certain embodiments, migration manager 70 may also configure the email application of the user to communicate with an email server 46 associated with destination domain 40 rather than the previous email server 36 associated with source domain 30. After migration manager 70 has completed operation, the computer 46 associated with the destination domain 40 will include substantially the same user settings and files as the computer 36 previously associated with source domain 30.

In certain embodiments, migration manager 70 may also retrieve and store the settings associated with the file system from the computer 32 associated with the source domain 30 and apply these file settings to the new user profiles for the computer 42 associated with the destination domain 40. An example of a file system may be NTFS. In certain embodiments, the settings may be related to the privileges to read and write certain applications and data files, such that the same privileges for the user of the computer 32 associated with the source domain 30 are applied to the user profile of the computer 42 associated with the destination domain 40.

It should be understood that modifications, additions, or omissions may be made to system 10. Additionally, while the embodiment of system 10 illustrated in FIG. 1 includes particular components that are each configured to provide certain functionality, alternative embodiments may include any appropriate combination of components with the described functionality divided between the components in any suitable manner.

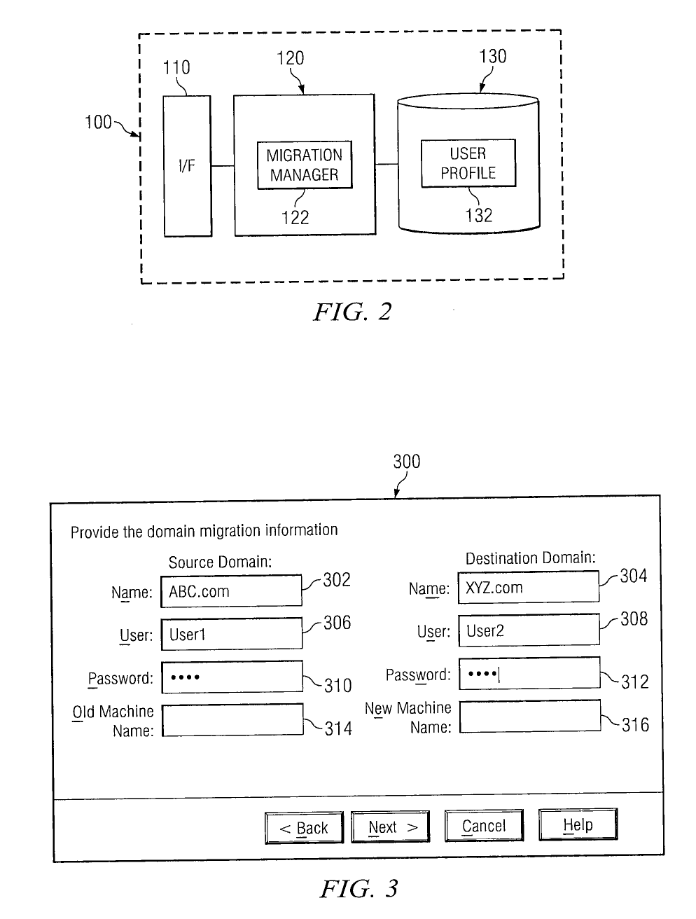

FIG. 2 is a block diagram illustrating a migration manager 122 executed by a computer 100 in accordance with a particular embodiment. Migration manager 122 may be similar to, and provide similar functionality as, migration manager 70 depicted in FIG. 1. According to the illustrated embodiment, computer 100 includes an interface 110, a processing module 120, and a memory 130. Processing module 120 may include migration manager 122. Memory 130 may include one or more user profiles 132. However, different embodiments may include all, some, or none of the components depicted in FIG. 2. Furthermore, migration manager 122 may be a separate stand alone device or it may be incorporated into or a part of another device.

Interface 110 may be any port or connection, real or virtual, including any suitable hardware and/or software that may allow computer 100 and/or migration manager 122 to exchange information and signals. Examples of interface 110 include a network interface card (NIC), Ethernet driver, universal serial bus (USB) drive, network card and/or firewall.

Processor 120 may be coupled to interface 110 and control the operation of computer 100 and/or migration manager 122. In particular, processor 120 may execute commands and instructions associated with migration manager 122. Examples of processor 120 include, application-specific integrated circuits (ASICs), field-programmable gate arrays (FGPAs), digital signal processors (DSPs), and any other suitable specific or general purpose processors.

As illustrated, processor 120 may include migration manager 122. In particular, migration manager 122 may be used to automate multiple tasks for migrating the user settings of a computer from a source domain 30 to a destination domain 40. Embodiments of migration manager 122 may include software or code associated with the CA Desktop Migration Manager®.

Memory 130 may be coupled to processor 120 and/or interface 110. Memory 130 may store processor instructions and/or any other appropriate information used by computer 100 and/or migration manager 122. Examples of memory 130 may include random access memory (RAM) devices, dynamic random access memory (DRAM), read only memory (ROM) devices, magnetic storage devices, optical storage devices, flash memory, or any other suitable data storage medium.

Embodiments of memory 130 may store user profiles 132 and/or user settings. User profile 132 may generally include any suitable information regarding the user settings of a computer.

FIG. 3 is a block diagram illustrating a graphical user interface 300 for automating the migration of user settings from a first domain to a second domain in accordance with a particular embodiment. Graphical user interface 300 may receive data to facilitate the automation of migrating the user settings for all of the computers of the user settings of a computer from a source domain to a destination domain. Data received by graphical user interface 300 may include source domain name 302 and the user name 306, password 310, and machine name of computer 314 associated with the source domain. Data received by graphical user interface 300 may also include destination domain name 304 and the user name 308, password 312, and machine name of the computer 316 associated with the destination domain. Data received by graphical user interface 300 may also include the new email server name 46 associated with destination domain 40. In certain embodiments, user name 306, 308, password 310, 312, and/or machine name 314, 316 may be identical for both the source domain and the destination domain. In certain embodiments, user name 306, 308, password 310, 312, and/or machine name 314, 316 for the destination domain may be different than the source domain. In certain embodiments user name 306, 308 may be associated with the network administrator.

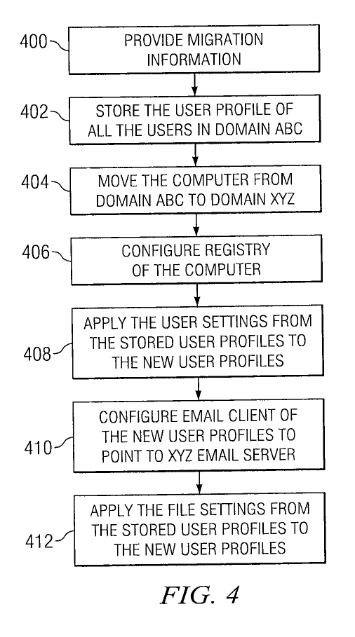

FIG. 4 is a flowchart illustrating a method for automating the migration of user settings from a first domain to a second domain in accordance with a particular embodiment. The illustrated method may be performed by one or more components of computer 100 and migration manager 122 discussed with respect to FIG. 2. Additionally, the illustrated method may be implemented as logic or code embodied on a computer embodied in a computer readable medium.

The illustrated method begins at step 400 where the operator of migration manager 70 may provide migration information via a graphical user interface. Migration information received by the graphical user interface may include source domain name and the user name, password, and machine name of computer associated with the source domain 30. Migration information received by graphical user interface may also include destination domain name and the user name, password, and machine name of the computer associated with the destination domain 40. Migration information received by graphical user interface may also include the new email server name 46 that is associated with destination domain 40.

At step 402, migration manager 70 may determine the user settings and files of one or more computers associated with the source domain 30 and store this information to memory or one or more files. At step 404, migration manager 70 may disassociate the one or more computers from the source domain 30 and associate the one or more computers with destination domain 40. At step 406, migration manager 70 may configure the registry of the one or more computers to set the RunOnce key to automatically run migration manager 70 after the one or more computers are restarted.

At step 408, migration manager 70 may extract the user settings stored in a file or memory and apply these user settings to one or more user profiles associated with the one or more computers 42 associated with the destination domain 40. At step 410, migration manager 70 may also configure the user settings of the one or more computers such that the email application of each user is directed to destination email server 46 associated with destination domain 40 rather than the source email server 36 associated with source domain 30.

At step 412, migration manager 70 may also retrieve and store the settings associated with the file system from the one or more computers 32 associated with the source domain 30 and apply these file settings to the new user profiles for the one or more computers 42 associated with the destination domain 40. For example, migration manager 70 may map the NTFS privileges of the one or more computers 32 associated with source domain 30 and apply the NTFS privileges to the new user profiles for the one or more computers 42 associated with the destination domain 40. Thus, when a user logs on to computer 42 located on destination domain 40, the user's experience will be substantially similar to when the user previously logged on to computer 32 located on source domain 30.

One skilled in the art will readily recognize that some of the steps illustrated in FIG. 4 may be combined, modified or deleted where appropriate, and additional steps may also be added to the flowchart. It should also be understood that steps may be performed in any suitable order without departing from the intended scope of the invention.

Modifications, additions, or omissions may be made to embodiments and components of the system without departing from its intended scope. As one example, the method and means for extracting the user settings of a computer in a first domain and applying the user settings to a computer in a second domain may be modified. Additionally, while certain embodiments and components of system have been described in detail, numerous changes, substitutions, variations, alterations and modifications may be ascertained by those skilled in the art. It is intended that the present disclosure encompass all such changes, substitutions, variations, alterations and modifications as falling within the spirit and scope of the appended claims.

What is claimed is:

1. A method for automating the migration of a plurality of user settings associated with a user from a first domain to a second domain, comprising:
receiving a plurality of user settings associated with a user of a computer associated with a first domain;
configuring the computer associated with the first domain for association with a second domain; and
creating a user profile of the user of the computer associated with the second domain, wherein the user profile comprises at least one of the plurality of the user settings associated with the user of the computer.

2. The method of claim 1, further comprising:
receiving the plurality of user settings associated with a plurality of users of computers associated with the first domain;
configuring each computer associated with the first domain for association with the second domain; and
creating a user profile of each of the plurality of the users of the computers associated with the second domain, wherein the user profile of each user comprises at least one of the plurality of the user settings.

3. The method of claim 1, further comprising displaying a desktop of the user of the computer associated with the second domain, wherein the displayed desktop is substantially identical to a displayed desktop of the user of the computer associated with the first domain.

4. The method of claim 1, further comprising associating an email server associated with the second domain in the user profile of the user of the computer associated with the second domain.

5. The method of claim 1, further comprising storing, in a file, the plurality of user settings associated with the user of the computer associated with a first domain.

6. The method of claim 1, further comprising:
receiving one or more file settings associated with the file system of the computer associated with the first domain; and
applying the one or more file settings of the file system of the computer associated with the first domain to the file system of the computer associated with the second domain.

7. The method of claim 1, further comprising displaying a graphical user interface, the graphical user interface receiving data comprising:
the first domain;
the second domain;
a user name associated with the first domain;
a user name associated with the second domain;
a user password associated with the first domain; and
a user password associated with the second domain.

8. A system for automating the migration of a plurality of user settings associated with a user from a first domain to a second domain, comprising:
one or more processors; and
memory coupled to the one or more processors and configured to store program instructions executable by the one or more processors to:
receive a plurality of user settings associated with a user of a computer associated with a first domain;
configure the computer associated with the first domain for association with a second domain; and
create a user profile of the user of the computer associated with the second domain, wherein the user profile comprises at least one of the plurality of the user settings associated with the user of the computer.

9. The system of claim 8, wherein the processor is further configured to:
receive the plurality of user settings associated with a plurality of users of computers associated with the first domain;
configure the computers associated with the first domain for association with the second domain; and
create a user profile of each of the plurality of the users of the computers associated with the second domain, wherein the user profile of each user comprises at least one of the plurality of the user settings.

10. The system of claim 8, wherein the processor is further configured to display a desktop of the user of the computer associated with the second domain, wherein the displayed desktop is substantially identical to a displayed desktop of the user of the computer associated with the first domain.

11. The system of claim 8, wherein the processor is further configured to associate an email server associated with the second domain in the user profile of the user of the computer associated with the second domain.

12. The system of claim 8, wherein the processor is further configured to store, in a file, the plurality of user settings associated with the user of the computer associated with a first domain.

13. The system of claim 8, wherein the processor is further configured to:
receive one or more file settings associated with the file system of the computer associated with the first domain; and
apply the one or more file settings of the file system of the computer associated with the first domain to the file system of the computer associated with the second domain.

14. The system of claim 8, wherein the processor is further configured to display a graphical user interface, the graphical user interface being configurable to receive data comprising:
the first domain;
the second domain;
a user name associated with the first domain;
a user name associated with the second domain;
a user password associated with the first domain; and
a user password associated with the second domain.

15. A computer readable medium comprising software for automating the migration of a plurality of user settings associated with a user from a first domain to a second domain, the software comprising computer code such that when executed is operable to:
receive a plurality of user settings associated with a user of a computer associated with a first domain;
configure the computer associated with the first domain for association with a second domain; and
create a user profile of the user of the computer associated with the second domain, wherein the user profile comprises at least one of the plurality of the user settings associated with the user of the computer.

16. The medium of claim 15, wherein the code is further operable to:
receive the plurality of user settings associated with a plurality of users of computers associated with the first domain;
configure the computers associated with the first domain for association with the second domain; and
create a user profile of each of the plurality of the users of the computers associated with the second domain, wherein the user profile of each user comprises at least one of the plurality of the user settings.

17. The medium of claim 15, wherein the code is further operable to display a desktop of the user of the computer associated with the second domain, wherein the displayed desktop is substantially identical to a displayed desktop of the user of the computer associated with the first domain.

18. The medium of claim 15, wherein the code is further operable to associate an email server associated with the second domain in the user profile of the user of the computer associated with the second domain.

19. The medium of claim 15, wherein the code is further operable to store, in a file, the plurality of user settings associated with the user of the computer associated with a first domain.

20. The medium of claim 15, wherein the code is further operable to:
receive one or more file settings associated with the file system of the computer associated with the first domain; and
apply the one or more file settings of the file system of the computer associated with the first domain to the file system of the computer associated with the second domain.
